(19) United States
(12) Patent Application Publication
(10) Pub. No.: US 2025/0384548 A1
(43) Pub. Date: Dec. 18, 2025

(54) METHOD, APPARATUS, SYSTEM, AND COMPUTER PROGRAM FOR PROCESSING AN IMAGE OF A SAMPLE

(71) Applicant: Leica Microsystems CMS GmbH, Wetzlar (DE)

(72) Inventors: Sean MCELROY, Wetzlar (DE); Won Yung CHOI, Wetziar (DE); Chi-Chou HUANG, Wetziar (DE)

(21) Appl. No.: 18/740,845

(22) Filed: Jun. 12, 2024

(51) Int. Cl. G06T 7/00; G06T 7/10

(52) U.S. Cl. CPC G06T 7/0012; G06T 7/10; G06T 2207/20081; G06T 2207/30024

(57) ABSTRACT

A method for processing an image of a sample. The method comprises receiving a 3D representation of the sample as an input, where the 3D representation comprising a plurality of input channels. The method further comprises segmenting the 3D representation 120 by segmenting and partitioning individual objects within the 3D representation. The method further comprises classifying the objects in the segmented 3D representation. The method further comprises deriving spatial information based on the classification of the objects. Deriving spatial information comprises performing a distance relation measurement between the objects. The method comprises at least one of analyzing the spatial information or triggering a visualization of the spatial information.

### TECHNICAL FIELD

Examples related to a method for processing an image of a sample, an apparatus, a computer program, and a system.

### BACKGROUND

Processing an image acquired using a biomedical imaging instrument may require multiple image data processing steps and significant domain expertise to derive adequate biological or pathological information from the image. For example, a 3D multiplexed cell image is an advanced imaging technique to visualize and analyze multiple molecular targets within 3D cell cultures or tissue samples simultaneously. Since the 3D multiplexed image can capture a spatial arrangement of cells and their internal structures within a sample, multiple biomarker targeting and various channels associated with the biomarkers are involved. However, due to the complexity of information comprised in such images, a domain expert may be required to process the complex image following a plurality of separate data processing steps and to perform quantitative analysis using the processing image. Hence, there may be a need for an improvement in processing an image of a sample.

### SUMMARY

This desire is addressed by the subject-matter of the independent claims.

The concept proposed in the present disclosure is based on a method of processing an image of a sample. The method can utilize a 3D representation of a sample as an input. The 3D representation comprises a plurality of input channels. The 3D representation is segmented by segmenting and partitioning individual objects within the 3D representation and the objects are classified. Then, spatial information based on the classification is derived, in which the method can perform a distance relation measurement between the objects. Further, the method can analyze the spatial information or can trigger a visualization of the spatial information. In this way, the method can assist a user to process the image of the sample and acquire the analysis of the spatial information without exporting or importing the output for further processing.

Examples provide a method of processing an image of a sample. The method comprises receiving a 3D representation of the sample as an input. The 3D representation comprises a plurality of input channels. Further, the method comprises segmenting the 3D representation by segmenting and partitioning individual objects within the 3D representation. The method comprises classifying the objects in the segmented 3D representation. Further, the method comprises deriving spatial information based on the classification of the objects. Deriving spatial information comprises performing a distance relation measurement between the objects. The method further comprises at least one of analyzing the spatial information or triggering a visualization of the spatial information. In this way, the method can streamline individual processing steps of the image of the sample to analyze the spatial information or to trigger a visualization of the spatial information.

In an example, the method may further comprise defining a region of interest within the 3D representation based on a user input. In this way, it may reduce a computational complexity, e.g. for the segmentation, by focusing on the region of interest and improve accuracy by reducing noise or undesirable information outside of the region of interest.

In an example, an input channel may correspond to at least one biomarker.

In an example, the method may further comprise grouping channels by at least one of a group of a biomarker type, a cell type, or a user defined condition.

In an example, the classification may be phenotyping. In this way, it may provide functional information of the objects and their interactions within the sample.

In an example, the classification may further comprise clustering the objects. The clustering enables to investigate relationships between clusters of similar objects.

In an example, the spatial information may be at least one of a group of a distance between vertices of neighboring cells, a distance between centroids of neighboring cells, a distance between different organelles or structures within a cell, clustering of cells, distribution of cells, cell density, or a texture feature from the segmented 3D representation.

In an example, an object is associated to at least one cluster and associated to at least one channel.

In an example, the method may further comprise receiving a selection based on at least one of the analysis of the spatial information or the spatial information or triggering a visualization 170 to highlight the selection in the 3D representation. In this way, the analysis of the spatial information may be associated with corresponding objects in the 3D representation, which facilitate to capture the relationship between the objects.

Examples provide an apparatus for processing an image of a sample. The apparatus comprises an input interface configured to receive a 3D representation of the sample as an input. The 3D representation comprises a plurality of input channels. The apparatus further comprises a processing circuitry configured to segment the 3D representation by segmenting and partitioning individual objects within the 3D representation, classify the objects in the segmented 3D representation, and derive spatial information based on the classification of the objects. Deriving spatial information comprises performing a distance relation measurement between the objects. The apparatus further comprises an output interface to output at least one of the spatial information or the analysis of the spatial information.

Examples related to a system comprising a microscope and a computer system.

Various examples of the present disclosure relate to a corresponding computer program with a program code for performing the above method when the computer program is executed on a processor.

### BRIEF DESCRIPTION OF THE FIGURES

Some examples of apparatuses and/or methods will be described in the following by way of example only, and with reference to the accompanying figures, in which

FIG. 1 illustrates an exemplary flowchart of a method of processing an image of a sample.

FIG. 2 illustrates an example of segmentation usable within an embodiment illustrated in FIG. 1;

FIG. 3 illustrates an example of classification usable within an embodiment illustrated in FIG. 1;

FIG. 4 illustrates an example of distance relation measurements usable within an embodiment illustrated in FIG. 1;

FIG. 5 illustrates an example of a highlighted selection within an embodiment illustrated in FIG. 1;

FIG. 6 illustrates an example of an apparatus for processing an image of a sample; and

FIG. 7 illustrates an example of a system for processing an image of a sample.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

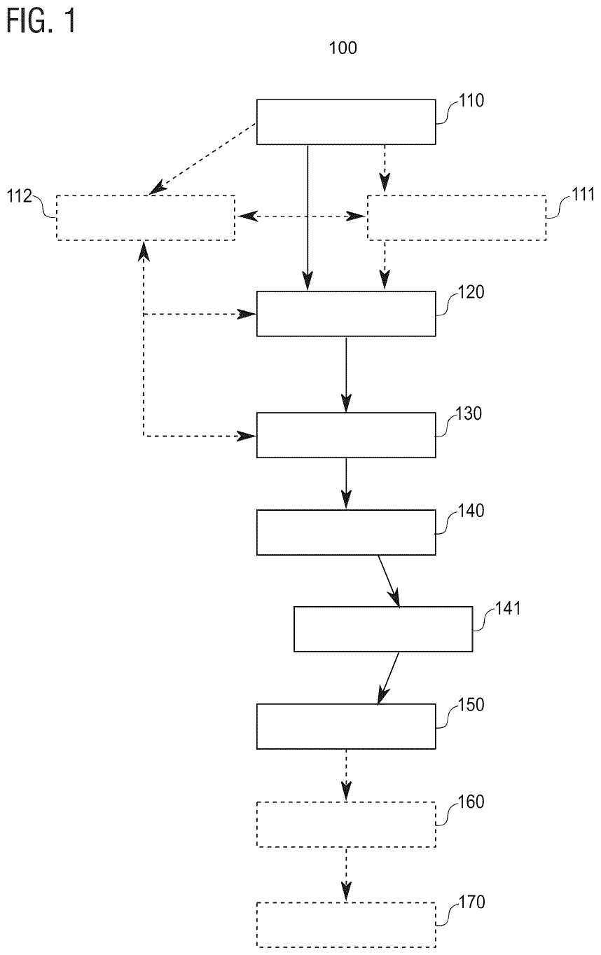

FIG. 1 illustrates an exemplary flowchart of a method 100 of processing an image of a sample. The method comprises receiving a 3D representation of the sample as an input 110. The 3D representation comprises a plurality of input channels. The method comprises segmenting the 3D representation 120 by segmenting and partitioning individual objects within the 3D representation and classifying the objects 130 in the segmented 3D representation. Further, the method 100 comprises deriving spatial information 140 based on the classification of the objects. Deriving spatial information 140 comprises performing a distance relation measurement 141 between the objects. The method 100 comprises at least one of analyzing the spatial information or triggering a visualization of the spatial information 150.

A 3D imaging technique has been gaining popularity due to advances in imaging instruments and processors which can compute large size of image data and provide complex data analysis and visualization of processed data. For example, in microscopy, a 3D multiplexed imaging technique is used to acquire detailed information, for example, about cell morphology, intracellular structures, and spatial organization of different molecular components. In this context, multiplexing can be understood as a usage of multiple fluorescent dyes to examine various elements within a sample.

Compared to 2D multiplexed imaging, 3D multiplexed imaging may require more complex and advanced image processing method due to the increased image dimensionality. For example, 3D reconstruction of a series of 2D images may be needed by stacking the images along one dimension, which accompanies correction of image alignment along the dimension. Furthermore, high computational demand and complexity of data set may be additional challenges in 3D multiplexed image processing.

In general, image processing comprises multiple steps for image reconstruction and analysis. The individual processing steps may be often performed separately by transferring data to different processing tools for 3D multiplexed imaging. For example, in microscopy, segmentation of individual elements in a sample are performed using a segmentation tool. A classification of the segmented elements is processed separately using a different classification tool. There may be several disadvantages using different tools for processing an image. For example, it may require transformation of image data for different processing tools in each step. Further, since the method steps might not be performed in a single tool, data generated by analyzing spatial information between elements within a sample might not be interactively associated with data generated by segmentation or classification steps. It might not facilitate an entire image processing flow and correction of errors propagated between each processing step.

The method 100 may provide a way to process the image of the sample by streamlining individual method step. The provided 3D presentation of the sample comprises a plurality of input channels. For example, the input channels are distinct and may be combined to generate a composite image, which may reveal relationships between channels. For example, in microscopy, a channel can be understood as a specific wavelength range of light that is detected. Each channel may correspond to a different fluorescent dye or marker used in the sample. The fluorescent markers may be used to label different cellular components, which may provide contrast in the 3D representation of the sample and facilitate segmentation of objects associated with one or more markers.

In an embodiment, an input channel may optionally correspond to at least one biomarker. Biomarkers can be understood as measurable indicators of a biological state or condition. Fluorescent markers are often used to label biomarkers. For example, an antibody conjugated with a fluorescent dye can bind specifically to a protein of interest, a biomarker, in a cell or a tissue.

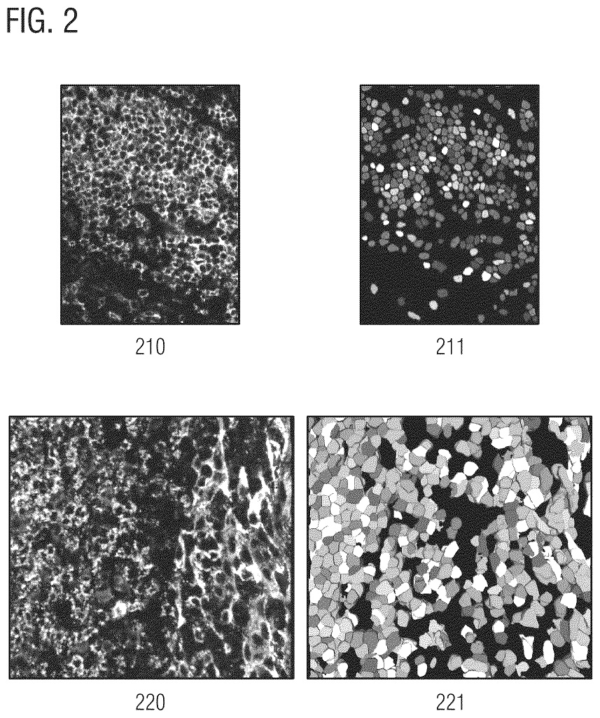

More details and aspects are mentioned in connection with the embodiments described above or below. The exemplary flowchart shown in FIG. 1 may comprise one or more optional additional features corresponding to one or more aspects mentioned in connection with the proposed concept or one or more examples described below (e.g. FIGS. 2-5).

FIG. 2 shows exemplary outputs of the segmentation 120. Segmenting the 3D representation 120 by segmenting and partitioning individual objects within the 3D representation may provide a way to identify each element in the sample. For illustrative purposes, 2D representations of samples are presented in FIG. 2. Individual objects in a first raw image 210 are identified and separated and a first segmented image 211 is provided by the segmentation 120. A second raw image 220 shows 5 different channels. In other words, 5 different dyes are used to target molecules within a sample and the second raw image 220 illustrates a combination of 5 channels. A second segmentation image 221 based on the second raw image 220 presents that individual object, e.g. cells, are segmented in 3D. It is worth noting that the number of channels is not limited to 5 but any number of channels can be used and images can be provided per channel and a combination of any number of channels. For example, in microscopy, it can be segmenting and partitioning individual objects, e.g. cells, cellular components, and molecules.

In an embodiment, the method 100 may optionally comprise defining a region of interest 111 within the 3D representation based on a user input. This may optionally be performed before the segmentation 120, which may reduce size of image data and influence of noise used for the segmentation 120. Therefore, it may improve processing efficiency and accuracy.

In an embodiment, the method 100 may optionally comprise grouping channels 112 by at least one of a group of a biomarker type, a cell type, or a user defined condition. It may be performed before the segmentation 120 or before the classification 130. Grouping channels 112 may simplify interpretation of complex datasets by reducing the number of individual images, e.g. an image per channel, that need to be analyzed separately and enable compute spatial correlation or co-localization between different biomolecules or structures within the sample.

Classifying the objects 130 in the segmented 3D representation can be understood as categorizing segmented cells or cellular components based on specific features or criteria. The classification 130 can provide insights into various biological process, disease states, or responses to treatments.

The classification 130 can be performed using various methods. For example, an object classifier may be used. It may need a user-defined example for the classifier training. A user may choose the number of classes to categorize the segmented objects or elements into each class. An object may belong to a single class after classification. For example, segmented apoptotic cells can be classified into four user-defined classes. A user can provide examples for classifier training per class. After classification, each cell, e.g. segmented objects, in the segmented image belong to a single class.

In an embodiment, the classification may optionally be phenotyping. Phenotype can be understood as observable traits of cells, such as their morphology, functionality, molecular expression, and spatial organization. In this context, in microscopy, phenotyping is a process of identifying and characterizing observable traits of cells through different approaches. For example, immune cells can be classified into 4 known classes using different measurements per class with user selection of examples. Cells can belong to multiple (or no) classes. It is worth noting that the number of classes are not limited to any specific number.

The classification 130 may optionally be clustering, which may identify cell phenotypes. For example, clustering can be performed using k-means. In another example, phenograph-leiden method can be used to cluster.

For example, k-means can be understood as an unsupervised machine learning algorithm for clustering similar data points, e.g. cells, into groups. For the classification 130, k-means may be perform using following methods: A user may define K cluster number, for example 4 clusters. Then, random initialization can be performed, for example, by selecting arbitrary 4 distinct data points, e.g. cells. It may also be called as cluster centroids. In an expectation step, every object is assigned to the closest cluster centroid. In minimization step, the cluster centroid is moved to the average of the points in a cluster. The expectation and the minimization steps may be repeated until there are no changes in the cluster. The classification 130 using k-means may be efficient for data when a user has a prior knowledge about the number of clusters.

For example, phenograph-leiden clustering can be understood as an unsupervised automated clustering method for high dimensional data. The classification 130 using pheonograph-leiden can construct a k-nearest neighbor (k-NN) graph from high-dimensional single-cell data. The k-NN graph can be understood as a type of graph, which identifies relationship between data points in a dataset. In the k-NN graph, each node represents data points in the dataset. An edge exists between a node and each of its k-NNs, where k is a natural number. The distance between nodes is typically measured using a metric, e.g. Euclidean distance or any distance measure depending on applications. For example, in microscopy, for each cell, distances between a cell and all the other cells are calculated and k-NNs for each cell are identified. Then, a graph is generated where each cell is a node, and edges connect each cell to its k-NNs.

Then, Leiden algorithm is applied to detect communities within the k-NN graph. For example, the resulting clusters represent different cell populations or phenotypes within the single-cell dataset. This method may be beneficial when a user wants to discover the number of phenotypes exists within the sample without prior knowledge.

In an embodiment, an object may optionally be associated to at least one cluster and associated to at least one channel. The segmentation 120 separates individual objects within the 3D representation. In the classification 130, each object may be associated to at least one cluster and associated to at least one channel.

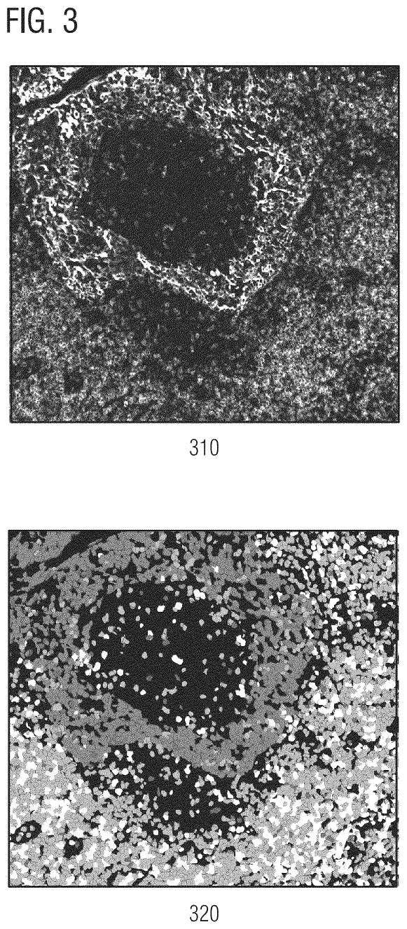

More details and aspects are mentioned in connection with the embodiments described above or below. The example shown in FIG. 2 may comprise one or more optional additional features corresponding to one or more aspects mentioned in connection with the proposed concept or one or more examples described above (e.g. FIG. 1) or below (e.g. FIGS. 3-5).

FIG. 3 shows an example of the classification 130. A raw image 310 comprises 5 channels and an output by phenotyping 320 shows segmented cells classified into different groups or clusters or classes. It is worth nothing that the number of channels used for the classification 130 can be chosen depending on applications.

For example, further, sub-classes or sub-clusters may be generated, using the classification 130 within existing classes. It may reveal a hierarchical structure and enhance marker identification.

Deriving spatial information 140 is preceded by the classification 140. Deriving spatial information 140 based on the classification of the objects may provide insights into the organization, interaction, and function of the objects within the sample. For examples, cells do not function in isolation; they are part of complex tissues with specific architectures. Therefore, spatial information between cells may help in understanding how cells are organized and how this organization affects their function. For example, spatial information between classes or clusters, where segmented elements or objects are associated, may be derived in this step as well.

The derivation of spatial information 140 comprises performing a distance relation measurement 141 between the objects. For example, the distance relation measurement may provide the formation of tissues and organs. Spatial distribution of pathogens and immune cells within a sample may be related to infection mechanisms and the effectiveness of immune responses.

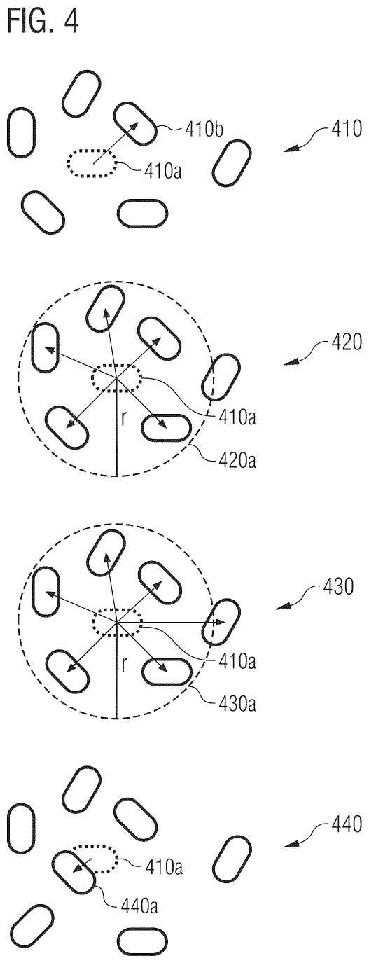

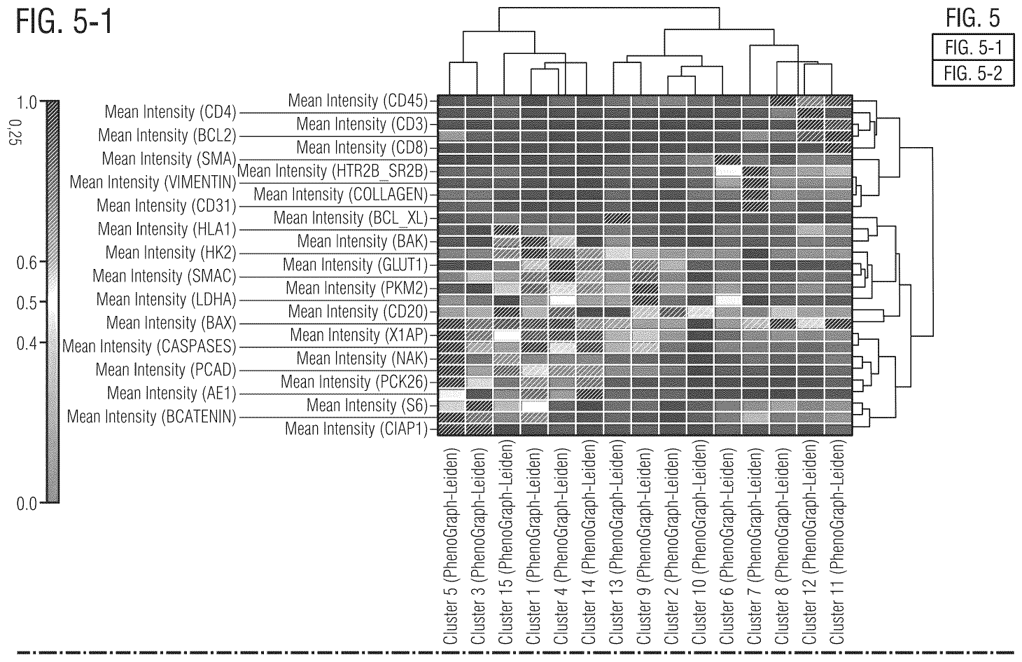

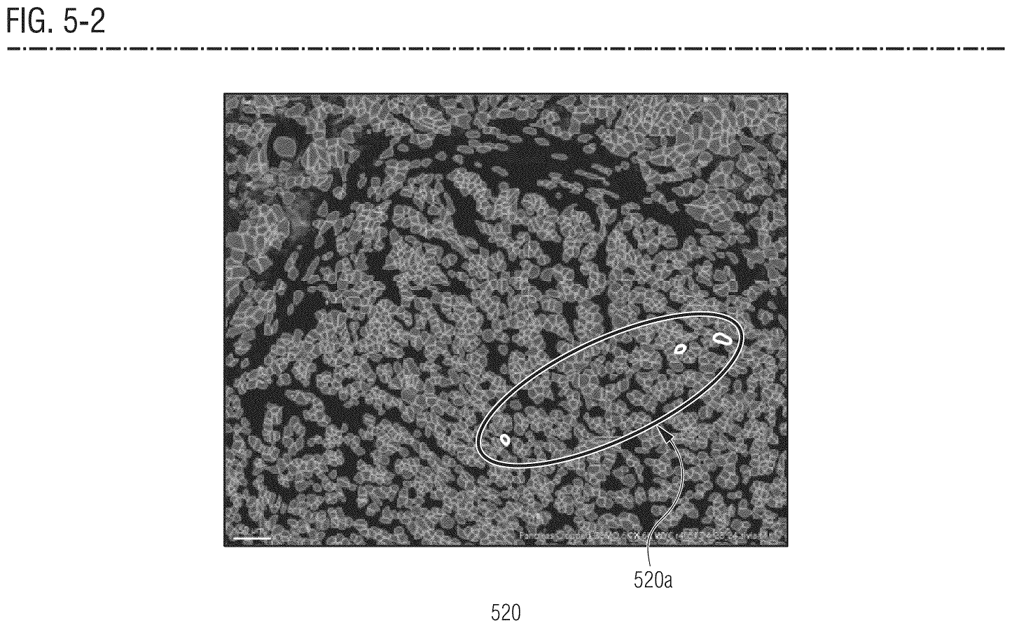

More details and aspects are mentioned in connection with the embodiments described above or below. The example shown in FIG. 3 may comprise one or more optional additional features corresponding to one or more aspects mentioned in connection with the proposed concept or one or more examples described above (e.g. FIGS. 1-2) or below (e.g. FIGS. 4-5).

There are different measurement methods for the distance relation measurement. FIG. 4 illustrates exemplary relation measurements between objects above mentions. A nearest object calculation 410 shows an object 410a, namely set 1, and its nearest object 410, namely set 2. Nearest N objects in a search range of radius r, e.g. 5 objects, 420 shows the object 410a and 5 objects within the radius of r 420a. All objects in a search range of r 430 shows the object 410a and 6 objects a within the radius of r 430. Lastly, overlapping 440 shows the object 410a and an overlapping object 440a. For example, any of the above mentioned measurement methods can be used for the distance relation measurement.

In an embodiment, the spatial information may optionally be one of a group of a distance between vertices of neighboring cells, a distance between centroids of neighboring cells, a distance between different organelles or structures within a cell, clustering of cells, distribution of cells, cell density, and a texture features from the segmented 3D representation. The distance between vertices between can be also called as a vertex-to-vertex distance. For example, in the segmentation 120, cells in the sample may adopt polygonal shapes. Vertex can be understood a point where the edges of these polygons meet. As an example, the vertex-to-vertex distance is the Euclidean distance between two adjacent vertices. The vertex-to-vertex distance may capture a complexity in a morphology of cells by measuring cell interactions at their boundaries.

As mentioned above referring to FIG. 1, the method 100 comprises at least one of analyzing the spatial information or triggering a visualization of the spatial information 150. Analyzing the spatial information 150 can provide a plurality of information. For example, calculation using a metric for an object, cluster, class, sub-cluster, or sub-class. For example, a Pearson correlation coefficient between a measurement for an object, a cluster, a class, a sub-cluster, or a sub-class. For example, a relationship between clusters and selected measurements or between classes and selected measurements. A measurement may be a mean intensity for a channel or be defined by a user. As an example, dendrogram may be generated by analyzing the spatial information. Dendrogram can be understood as an arrangement of class or clusters formed by hierarchical clustering. In the context of cell imaging, a dendrogram may represent similarities and differences between various cells or cell populations based on specific characteristics, e.g. phenotypic markers. For example, dendrogram can perform hierarchical clustering to group cells with similar channel or marker expression lever, e.g. CD8 expression levels. It is worth nothing that it is not limited to dendrogram and Pearson correlation coefficient, but it may be various types e.g. violin plot, scatter plot, binned scatter plot, histogram, marker-cluster dendrogram, Pearson correlation heatmap, and dimensionality reduction plot. The analyzation of the spatial information 150 may help identify different subsets of a selected object or a cluster.

Triggering a visualization of the spatial information 150 may provide a way to interpret the spatial information in connection with the visualization and help a user to associate the spatial information with the classified objects graphically.

More details and aspects are mentioned in connection with the embodiments described above or below. The example shown in FIG. 4 may comprise one or more optional additional features corresponding to one or more aspects mentioned in connection with the proposed concept or one or more examples described above (e.g. FIGS. 1-3) or below (e.g. FIG. 5).

In an embodiment, the method 100 may optionally comprise receiving a selection 160 based on at least one of the analysis of the spatial information or the spatial information or triggering a visualization 170 to highlight the selection in the 3D representation. For example, as described above, a single cell may be selected in a dendrogram then a visualization may be triggered so as to highlight a cluster to which the cell is associated in the 3D representation. Based on application, the selection may be highlighted in the segmented 3D representation or in the classified 3D representation. It may provide a way to investigate a selected object in biological context presented in the 3D representation of the sample interactively.

For illustrative purposes, FIG. 5 shows an example of an analysis 510 of spatial information based on the 3D representation and a segmented 3D representation 520 of a sample. As described above, a selection may be made in the analysis of the spatial information, i.e. dendrogram as illustrated in FIG. 5. A received selection 510a is then may trigger a visualization to highlight the selection 510a in the segmented 3D representation 520. Three cells associated to the selection 510a are highlighted in the segmented 3D representation 520.

FIG. 5 presents receiving a selection 160 based on the analysis of the spatial information or triggering the visualization 170 to highlight the selection in the segmented 3D representation referring to the method step. It may provide a way to interpret the analysis, relationships between the selected cells in the context of the native environment showing spatial distribution of the cells interactively.

Referring to FIGS. 1 to 5, therefore, the method 100 may provide an improved way to process the image of the sample by offering comprehensive method steps to derive spatial information from a 3D representation of the sample and to analyze the spatial information interactively. For example, it may capture an organization and interaction of cells within their native 3D environment and reveal tissue architecture and cellular microenvironments.

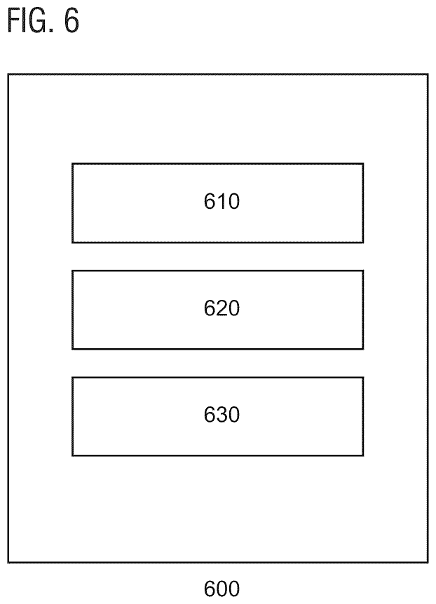

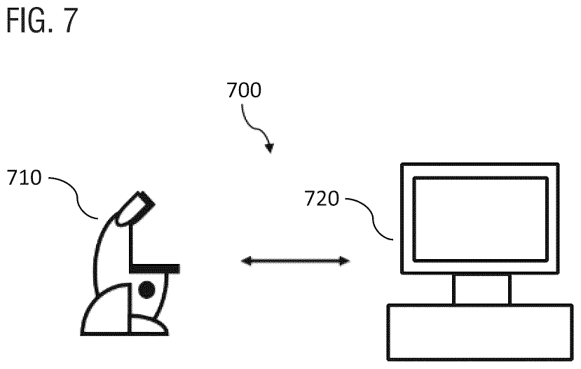

In FIGS. 6 and 7, an apparatus 600 and a system 700 for processing an image of a sample are described, which utilizes the method 100 and one or more aspects mentioned in connection with the proposed concept or one or more examples described above (e.g. FIGS. 1-5).

FIG. 6 illustrates an example of the apparatus 600 for processing an image of a sample. The apparatus comprises an input interface 610 to receive a 3D representation of the sample as an input. The 3D representation comprises a plurality of channels. Further, the apparatus comprises a processing circuitry 620. The processing circuitry is configured to segment the 3D representation by segmenting and partitioning individual objects within the 3D representation, to classify the objects in the segmented 3D representation, and to derive spatial information based on the classification of the objects. Deriving spatial information comprises performing a distance relation measurement between objects. The apparatus comprises an output interface 630 to output the spatial information.

As shown in FIGS. 1 to 4, the input interface 610 received the 3D representation of the sample as an input, which comprises a plurality of channels referring to FIG. 1. The processing circuitry segments the 3D representation by segmenting and partitioning individual objects within the 3D representation referring to FIG. 2, classify the objects in the segmented 3D representation referring to FIG. 3, and derive spatial information based on the classification of the objects, comprising the distance relation measurement referring to FIG. 4. Therefore, the apparatus may provide a way to process the image of the sample to derive the spatial information without a plurality of transmissions and receptions of outputs generated by the processing circuitry 620 to different apparatus for the segmentation, the classification, or the derivation of the spatial information separately.

In an embodiment, the processing circuitry 620 may optionally be configured to define a region of interest within the 3D representation based on a user input using the input interface. As described above, referring to FIG. 1, it may reduce computational complexity and influence of noise and irrelevant features presented in the 3D representation.

More details and aspects are mentioned in connection with the embodiments described above or below. The example shown in FIG. 6 may comprise one or more optional additional features corresponding to one or more aspects mentioned in connection with the proposed concept or one or more examples described above (e.g. FIGS. 1-5).

In an embodiment, a channel may optionally correspond to at least one biomarker.

In an embodiment, the processing circuitry 620 may optionally be configured to group at least one of a group of a biomarker type, a cell type, and a user defined condition.

In an embodiment, the processing circuitry 620 may optionally be configured to cluster the objects.

In an embodiment, the spatial information may optionally be at least one of a group of a distance between vertices of neighboring cells, a distance between centroids of neighboring cells, a distance between different organelles or structures within a cell, clustering of cells, distribution of cells, cell density, or a texture feature from the segmented 3D representation.

In an embodiment, an object may optionally be associated to at least one cluster and associated to at least one channel.

In an embodiment, the processing circuitry 620 may optionally be configured to receive a selection based on the spatial information or trigger a visualization to highlight the selection in the 3D representation. Referring to FIG. 5, it may enable a user to investigate the spatial information in its native 3D representation based on the selection interactively.

Therefore, the apparatus 600 may offer a user a mean to capture relationship between a biomarker expression and a spatial relationship based on a cell type, a phenotype, or a structure of interest.

Some embodiments relate to a microscope comprising a system as described in connection with one or more of the FIGS. 1 to 6. Alternatively, a microscope may be part of or connected to a system as described in connection with one or more of the FIGS. 1 to 6. FIG. 7 shows a schematic illustration of the system 700 configured to perform a method described herein. The system 700 comprises a microscope 710 and a computer system 720. The microscope 710 is configured to take images and is connected to the computer system 720. The computer system 720 is configured to execute at least a part of a method described herein. The computer system 720 may be configured to execute a machine learning algorithm. The computer system 720 and microscope 710 may be separate entities but can also be integrated together in one common housing. The computer system 720 may be part of a central processing system of the microscope 710 and/or the computer system 720 may be part of a subcomponent of the microscope 710, such as a sensor, an actor, a camera or an illumination unit, etc. of the microscope 710.

The computer system 720 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 720 may comprise any circuit or combination of circuits. In one embodiment, the computer system 720 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 720 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system 720 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 720 may also include a display device, one or more speakers, and a keyboard and/or controller, which can include a mouse, trackball, touch screen, voice-recognition device, or any other device that permits a system user to input information into and receive information from the computer system 720.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine-readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value.

Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

### LIST OF REFERENCE SIGNS

100 method
110 receiving a 3D representation
111 defining a region of interest
112 grouping channels
120 segmenting the 3D representation
130 classifying the objects
140 deriving spatial information
141 performing a distance relation measurement
150 analyzing the spatial information or triggering a visualization of the spatial information
160 receiving a selection
170 triggering a visualization
210 first raw image
211 first segmented image
220 second raw image
221 second segmented image
310 raw image
320 output
410 nearest object calculation
410a object
410b nearest object
420 nearest N objects in a search range of radius r
420a 5 objects a within the radius of r
430 all objects in a search range of r
430a 6 objects within the radius of r
440 overlapping
440a overlapping object
510 analysis
520 segmented 3D representation
600 apparatus
610 input interface
620 processing circuitry
630 output interface
700 system
710 microscope
720 computer system

What is claimed is:

1. A method (100) for processing an image of a sample, the method comprising:
receiving a 3D representation 110 of the sample as an input, the 3D representation comprising a plurality of input channels;
segmenting the 3D representation 120 by segmenting and partitioning individual objects within the 3D representation;
classifying the objects 130 in the segmented 3D representation;
deriving spatial information 140 based on the classification of the objects, comprising:
performing a distance relation measurement 141 between the objects; and
at least one of analyzing the spatial information or triggering a visualization of the spatial information 150.

2. The method of claim 1, further comprising: defining a region of interest 111 within the 3D representation based on a user input.

3. The method of claim 1, wherein an input channel corresponds to at least one biomarker.

4. The method of claim 1, further comprising: grouping channels 112 by at least one of a group of a biomarker type, a cell type, or a user defined condition.

5. The method of claim 1, wherein the classification is phenotyping.

6. The method of claim 1, the classification further comprising: clustering the objects.

7. The method of claim 1, wherein the spatial information is at least one of a group of a distance between vertices of neighboring cells, a distance between centroids of neighboring cells, a distance between different organelles or structures within a cell, clustering of cells, distribution of cells, cell density, or a texture feature from the segmented 3D representation.

8. The method of claim 1, wherein an object is associated to at least one cluster and associated to at least one channel.

9. The method of claim 1, further comprising:
receiving a selection based on at least one of the analysis of the spatial information or the spatial information; and
triggering a visualization to highlight the selection in the 3D representation.

10. An apparatus for processing an image of a sample, the apparatus comprising:
an input interface to receive a 3D representation of the sample as an input, the 3D representation comprising a plurality of input channels;
a processing circuitry, configured to
segment the 3D representation by segmenting and partitioning individual objects within the 3D representation,
classify the objects in the segmented 3D representation,
derive spatial information based on the classification of the objects, comprising performing a distance relation measurement between the objects, and
analyze the spatial information; and
an output interface to output at least one of the spatial information or the analysis of the spatial information.

11. The apparatus of claim 10, the processing circuitry is further configured to define a region of interest within the 3D representation based on a user input using the input interface.

12. The apparatus of claim 10, wherein an input channel corresponds to at least one biomarker.

13. The apparatus of claim 10, the processing circuitry is further configured to group channels by at least one of a group of a biomarker type, a cell type, or a user defined condition.

14. The apparatus of claim 10, the processing circuitry is further configured to cluster the objects.

15. The apparatus of claim 10, wherein the spatial information is at least one of a group of a distance between vertices of neighboring cells, a distance between centroids of neighboring cells, a distance between different organelles or structures within a cell, clustering of cells, distribution of cells, cell density, or a texture feature from the segmented 3D representation.

16. The apparatus of claim 10, wherein an object is associated to at least one cluster and associated to at least one channel.

17. The apparatus of claim 10, the processing circuitry 620 further configured to
receive a selection based on the spatial information; and
trigger a visualization to highlight the selection in the 3D representation.

18. A tangible, non-transitory computer-readable medium having instructions thereon, which, upon execution by one or more hardware processors, facilitates execution of the following steps:
receiving a 3D representation of the sample as an input, the 3D representation comprising a plurality of input channels;
segmenting the 3D representation by separating individual objects within the 3D representation;
classifying the objects in the segmented 3D representation;
deriving spatial information based on the classification of the objects, comprising:
performing a distance relation measurement between the objects; and
analyzing or visualizing the spatial information.

19. A system for processing an image of a sample, the system comprising:
a microscope configured to generate a 3D representation of the sample; and
a computer system comprising:
an input interface to receive the 3D representation of the sample as an input, the 3D representation comprising a plurality of input channels;
a processing circuitry, configured to
segment the 3D representation by separating individual objects within the 3D representation,
classify the objects in the segmented 3D representation,
derive spatial information based on the classification of the objects, comprising performing a distance relation measurement between the objects, and
analyze the spatial information; and
an output interface to output the spatial information or the analysis of the spatial information.
